(19) United States
(12) Patent Application Publication
(10) Pub. No.: US 2015/0205981 A1
(43) Pub. Date: Jul. 23, 2015

(54) Handheld Communication Device Supporting Base

(71) Applicant: LINKTEL INC., Taipei (TW)

(72) Inventors: Hong-Lin Lee, Taipei (TW); Wen-Hsiung Tsai, Taipei (TW); Tzi-I Yang, Taipei (TW)

(73) Assignee: LINKTEL INC., Taipei (TW)

(21) Appl. No.: 14/256,018

(22) Filed: Apr. 18, 2014

(30) Foreign Application Priority Data
Jan. 17, 2014 (TW) 103200980

(51) Int. Cl. G06K 7/00; G06K 7/10

(52) U.S. Cl. CPC G06K 7/0056; G06K 7/10415

(57) ABSTRACT

A handheld communication device supporting base is disclosed. The handheld communication device supporting base is used for placing a handheld communication device and reading a card. The handheld communication device supporting base includes a handheld communication device placement notch, a reader device, and a processor. The handheld communication device placement notch is used for placing the handheld communication device. The reader device is located next to the handheld communication device placement notch, used for reading the card, to obtain the reading information. The processor is electrically connected to the reader device, used for transferring the reading information to the handheld communication device via the handheld communication device placement notch, allowing the reading information to be transferred via the handheld communication device.

### BACKGROUND OF THE INVENTION

1. Field of the Invention

The present invention relates to a handheld communication device supporting base; more particularly, the present invention relates to a handheld communication device supporting base with a function of reading card.

2. Description of the Related Art

As the handheld communication device develops, many kinds of related products are also produced. In the prior art, the supporting base for placing the handheld communication device is already disclosed. But the supporting base of the prior art, which is only used for placing the handheld communication device, does not have other additional function. The handheld communication device can only be idly placed on the supporting base. Therefore, the function of the handheld communication device is wasted. Besides, in the prior art, the reading device for using the credit card transfers the information via a wired connection mode, such that there are many using restrictions; furthermore, the reading device is not portable, so it is inconvenient for a user who needs to constantly move.

Therefore, there is a need to provide a new supporting base of the handheld communication device, to solve the disadvantage in the prior art.

### SUMMARY OF THE INVENTION

It is an object of the present invention to provide a handheld communication device supporting base with a function of reading card.

To achieve the abovementioned object, the handheld communication device supporting base of the present invention is used for placing a handheld communication device and reading a card. The handheld communication device supporting base includes a handheld communication device placement notch, a reader device, and a processor. The handheld communication device placement notch is used for placing the handheld communication device. The reader device is located next to the handheld communication device placement notch, used for reading the card, to obtain the reading information. The processor is electrically connected to the reader device, used for transferring the reading information to the handheld communication device via the handheld communication device placement notch, allowing the reading information to be transferred via the handheld communication device.

### BRIEF DESCRIPTION OF THE DRAWINGS

FIG. 1 illustrates a schematic drawing of the handheld communication device supporting base of the present invention.

FIG. 2 illustrates a perspective schematic drawing of the handheld communication device supporting base in one embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

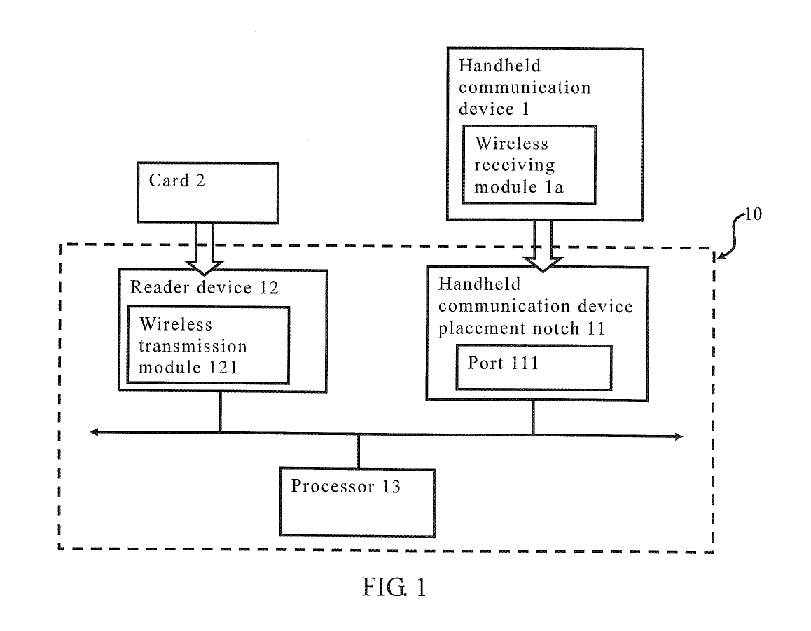

Please refer to FIG. 1, which illustrates a schematic drawing of the handheld communication device supporting base of the present invention.

The handheld communication device supporting base 10 of the present invention is used for placing a handheld communication device 1, and reading a card 2. The handheld communication device supporting base 10 includes a handheld communication device placement notch 11, a reader device 12, and a processor 13. The handheld communication device placement notch 11 is used for placing the handheld communication device 1. The size of the handheld communication device placement notch 11 can be adjusted according to the specification of the handheld communication device 1, however, the present invention is not limited its form.

The reader device 12 is located next to the handheld communication device placement notch 11, used for reading the card 2, to obtain a reading information. The reader device 12 can be a contact reader device or a contactless reader device, used for reading a contact card or a contactless card. The contact reader device can be a chip or barcode type reader device, for reading the contact card, such as the credit card issued by the domestic or international card institution. The contactless reader device is used for reading the contactless card, such as the credit card or the easy card with the sensing function, the contactless reader device can also read the E-ticket or the business card; therefore, the contactless reader device can be a Radio Frequency Identification (RFID) reading device or a Near Field Communication (NFC) device, but the present invention is not limited to the abovementioned device.

The processor 13 is electrically connected to the reader device 12. The processor 13 can be formed by a hardware, a combination of the hardware and the firmware, or a combination of the hardware and the software, but the present invention is not limited to that design. The processor 13 is used for transferring the reading information to the handheld communication device 1 via the handheld communication device placement notch 11, allowing the reading information to be transferred via the handheld communication device 1, such as transferring to a financial center (not shown in the figure), but the present invention is not limited to that designed. The transferring method of using the handheld communication device 1 is already disclosed in the prior art, therefore, there is no need for further description.

In one embodiment of the present invention, the handheld communication device placement notch 11 includes a port 111 used for electrically connected to the handheld communication device 1. Therefore, the processor 13 can control the reading information to be transferred to the handheld communication device 1 via the port 111.

In another embodiment of the present invention, the reader device 12 includes a wireless transmission module 121, and the handheld communication device 1 includes a wireless receiving module 1 a. The reading information is transferred to the wireless receiving module la of the handheld communication device 1 via the wireless transmission module 121.

It is to be known that, the handheld communication device supporting base 10 of the present invention can include the port 111 of the handheld communication device placement notch 11 and the wireless transmission module 121 of the reader device 12 at the same time, but the reading information is not limited to be transferred via only one kind of transferring path of present invention.

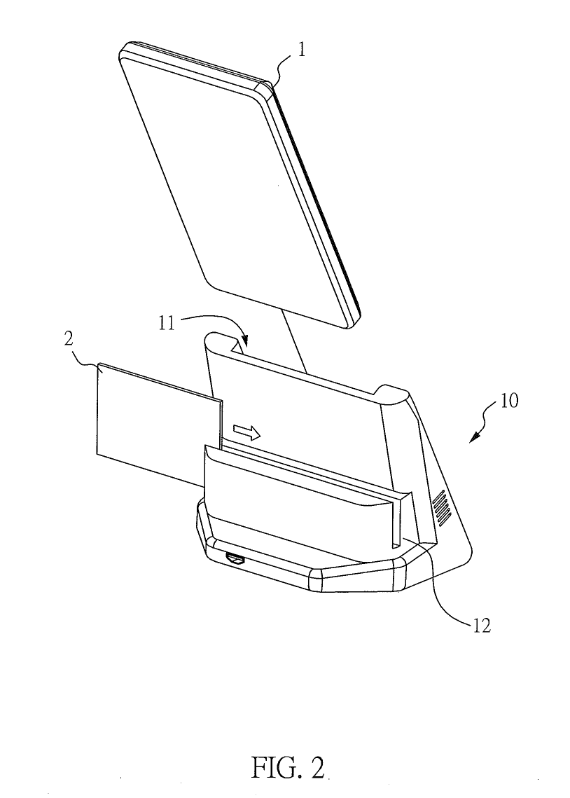

Please refer to FIG. 2, which illustrates a perspective schematic drawing of the handheld communication device supporting base in one embodiment of the present invention.

In the present embodiment, the reader device 12 can be a chip reader device, and the card 2 can be a contact card, but the present invention is not limited to that design. As shown in FIG. 2, if the user wants to use the card 2, the user can directly use the reader device 12 to use the card 2. After the reader device 12 obtains the reading information of the card 2, the reading information will be transferred to the handheld communication device 1 via the wireless transmission module 121 or the port 111, such that the handheld communication device 1 can transfer reading information transferred from the card 2 to the outside.

Via the structure of the handheld communication device supporting base 10 of the present invention, the handheld communication device supporting base 10 can combine to the handheld communication device 1, and have the function of reading the card 2, such that the handheld communication device supporting base 10 can make full use of the handheld communication device 1.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A handheld communication device supporting base, used for placing a handheld communication device and reading a card, the handheld communication device supporting base comprising:
a handheld communication device placement notch, used for placing the handheld communication device;
a reader device, located next to the handheld communication device placement notch, used for reading the card, to obtain a reading information; and
a processor, electrically connecting to the reader device, used for transferring the reading information to the handheld communication device via the handheld communication device placement notch, allowing the reading information to be transferred via the handheld communication device.

2. The handheld communication device supporting base as claimed in claim 1, wherein the handheld communication device placement notch comprises a port for electrically connecting to the handheld communication device; wherein the reading information is transferred to the handheld communication device via the port.

3. The handheld communication device supporting base as claimed in claim 1, wherein the reader device comprises a wireless transmission module, and the handheld communication device comprises a wireless receiving module;
wherein the reading information is transferred to the wireless receiving module of the handheld communication device via the wireless transmission module.

4. The handheld communication device supporting base as claimed in claim 1, wherein the reader device is a contact reader device, used for reading a contact card.

5. The handheld communication device supporting base as claimed in claim 1, wherein the reader device is a contactless reader device, used for reading a contactless card.
